(19) United States
(12) Patent Application Publication
(10) Pub. No.: US 2021/0335322 A1
(43) Pub. Date: Oct. 28, 2021

(54) DISPLAY APPARATUS AND CONTROL METHOD THEREOF

(71) Applicant: CANON KABUSHIKI KAISHA, Tokyo (JP)

(72) Inventor: Hironobu Hoshino, Tokyo (JP)

(21) Appl. No.: 17/237,761

(22) Filed: Apr. 22, 2021

(30) Foreign Application Priority Data
Apr. 27, 2020 (JP) 2020-078369

(51) Int. Cl. G09G 5/10

(52) U.S. Cl. CPC G09G 5/10; G09G 2320/0626

(57) ABSTRACT

A display apparatus according to the present invention, includes: a light source; a first transmissive panel configured to transmit light emitted by the light source; a second transmissive panel configured to transmit light transmitted through the first transmissive panel; and at least one memory and at least one processor which function as: an obtaining unit configured to obtain inthrmation on a display brightness; and a control unit configured to control a transmittance of the first transmissive panel and a transmittance of the second transmissive panel, wherein the control unit further controls, based on the information obtained by the obtaining unit, a display brightness range that limits a change in the transmittance of the first transmissive panel corresponding to a change in the display brightness to not more than a predetermined change.

### BACKGROUND OF THE INVENTION

### Field of the Invention

The present invention relates to a display apparatus and a control method of th display apparatus.

### Description of the Related Art

Improvement has been sought in the visibility of display images (images displayed on display surfaces) of display apparatuses. Specifically, improvement has been sought in the ratio (contrast ratio) between the brightness of a bright part and the brightness of a dark part of display images.

For example, Japanese Patent Application Publication Nos. 2016-110099 and 2018-041056 disclose conventional techniques relating to display apparatuses that achieve improved visibility. Japanese Patent Application Publication Nos. 2016-110099 and 2018-041056 each describe a display apparatus including a liquid crystal panel (front panel) that is arranged closer to a user and a liquid crystal panel (rear panel) arranged between the front panel and the light source. Such a display apparatus with a dual-layer panel structure is called a dual-layer liquid crystal display apparatus.

With a dual-layer liquid crystal display apparatus, when the display image normal to the front panel (display surface) is viewed, the pixels (display elements; liquid crystal elements) of the front panel are paired with the pixels (pixels of the rear panel) directly behind these pixels. The user perceives the light transmitted through those pixels. The contrast ratios of the two liquid crystal panels are thus combined, enabling the display image to be perceived with a higher contrast ratio.

The dual-layer liquid crystal display apparatus is characterized by an optical gap formed between the front panel and the rear panel. When the display image is viewed at an angle, instead of being viewed in a direction normal to the front panel, each front panel pixel is paired with a pixel (rear panel pixel) different from the pixel directly behind the front panel pixel. Consequently, when a display image is viewed at an angle, the image is perceived differently from when the image is viewed directly from the front. That is, a dual-layer liquid crystal display apparatus has a poor (narrow) view angle.

### SUMMARY OF THE INVENTION

The present invention provides a technique that improves the view angle of a display apparatus having a dual-layer panel structure.

The present invention in its first aspect provides a display apparatus including: a light source; a first transmissive panel configured to transmit light emitted by the light source; a second transmissive panel configured to transmit light transmitted through the first transmissive panel; and at least one memory and at least one processor which function as: an obtaining unit configured to obtain information on a display brightness; and a control unit configured to control a transmittance of the first transmissive panel and a transmittance of the second transmissive panel, wherein the control unit further controls, based on the information obtained by the obtaining unit, a display brightness range that limits a change in the transmittance of the first transmissive panel corresponding to a change in the display brightness to not more than a predetermined change.

The present invention in its second aspect provides a control method of a display apparatus including a light source, a first transmissive panel configured to transmit light emitted by the light source, and a second transmissive panel configured to transmit light transmitted through the first transmissive panel, the control method including: obtaining information on a display brightness; controlling a transmittance of the first transmissive panel and a transmittance of the second transmissive panel; and controlling, based on the obtained information, a display brightness range that limits a change in the transmittance of the first transmissive panel corresponding to a change in the display brightness to not more than a predetermined change.

The present invention in its third aspect provides a non-transitory computer readable medium that stores a program, wherein the program causes a computer to execute a control method of a display apparatus including a light source, a first transmissive panel configured to transmit light emitted by the light source, and a second transmissive panel configured to transmit light transmitted through the first transmissive panel, the control method including: obtaining information on a display brightness; controlling a transmittance of the first transmissive panel and a transmittance of the second transmissive panel; and controlling, based on the obtained information, a display brightness range that limits a change in the transmittance of the first transmissive panel corresponding to a change in the display brightness to not more than a predetermined change.

Further features of the present invention will become apparent from the following description of exemplary embodiments with reference to the attached drawings.

### BRIEF DESCRIPTION OF THE DRAWINGS

FIG. 1 is a block diagram showing a configuration example of a display apparatus;

FIGS. 2A to 2I are diagrams showing examples of various transmittances and the like;

FIGS. 3A to 3D are diagrams showing examples of various transmittances and the like;

FIGS. 4A to 4D are diagrams showing examples of various transmittances and the like;

FIG. 5 is a flowchart showing an operation example;

FIGS. 6A and 6B are diagrams showing examples of images;

FIG. 7 is a flowchart showing an operation example;

FIGS. 8A and 8B are diagrams showing examples of images; and

FIGS. 9A and 9B are diagrams showing examples of the relationship between the display brightness and the transmittances of the two panels.

### DESCRIPTION OF THE EMBODIMENTS

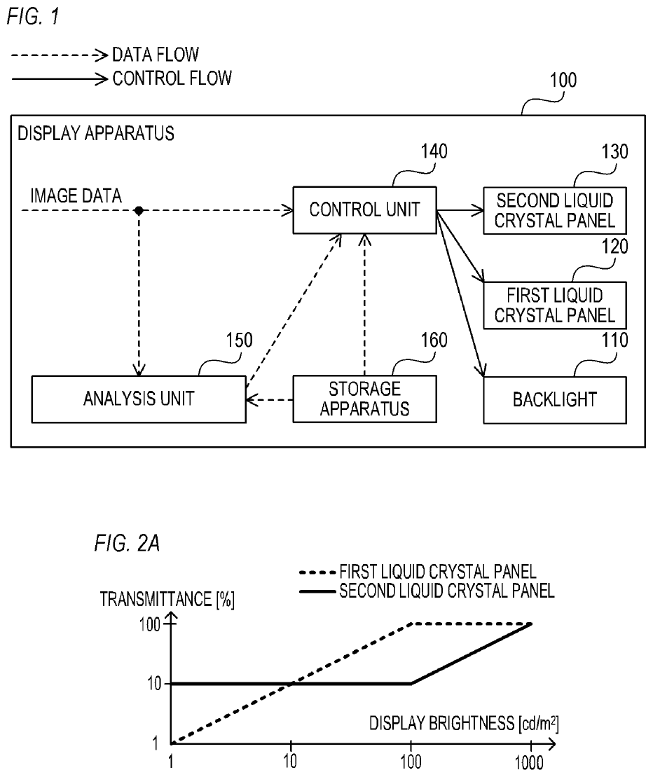

Preferred embodiments of the present invention are described below with reference to the accompanying drawings. FIG. 1 is a block diagram showing a configuration example of a display apparatus 100 of an embodiment. The display apparatus 100 includes a backlight 110, a first liquid crystal panel 120, a second liquid crystal panel 130, a control unit 140, an analysis unit 150, and a storage apparatus 160.

The backlight 110 is a light-emitting unit (light-emitting module; light emitting member) that illuminates the back surface of the first liquid crystal panel 120. The light source of the backlight 110 may be, for example, a light-emitting diode (LED), cold cathode fluorescent lamp (CCFL), or electro luminescence (EL) element.

The backlight 110 may have any configuration that can illuminate the back surface of the first liquid crystal panel 120. The backlight 110 may have any of various configurations, such as direct-lit, edge-lit, and flat light-source type. The light source of the backlight 110 may also have any configuration. In the description of the present embodiment, the backlight 110 is assumed to emit light of constant brightness, but the control unit 140 may control to change the light emission brightness (light emission amount) of the backlight 110.

The first liquid crystal panel 120 and the second liquid crystal panel 130 are liquid crystal panels. The first and second liquid crystal panels 120 and 130 may have any configuration as long as they function to transmit light with changeable transmittances. The configuration of the first and second liquid crystal panels 120 and 130 may be any of various configurations, such as active matrix configuration or in-plane switching (IPS) configuration. Instead of the first and second liquid crystal panels 120 and 130, other transmissive panels with transmission capability may be used. For example, a transmissive panel having micro-electro-mechanical system (MEMS) shutters as pixels (display elements) instead of the liquid crystal elements may be used.

The second liquid crystal panel 130 is arranged in front of the first liquid crystal panel 120. The first liquid crystal panel 120 transmits the light emitted by the backlight 110, and the second liquid crystal panel 130 transmits the light transmitted through the first liquid crystal panel 120.

The control unit 140 controls the transmittance of the first liquid crystal panel 120 and the transmittance of the second liquid crystal panel 130 based on the image to be displayed (image data). For example, the transmittance may be changed by controlling the applied voltage. With the transmittance controlled, the light from the backlight 110 passes through the first liquid crystal panel 120 and then the second liquid crystal panel 130, thereby displaying an image on the display surface (e.g., the front surface of the second liquid crystal panel 130) of the display apparatus 100.

The storage apparatus 160 stores various types of data (information). For example, the storage apparatus 160 pre-stores programs, which are read and executed by the control unit 140 and the analysis unit 150, the relationship between the display brightness, the transmittance of the first liquid crystal panel 120, and the transmittance of the second liquid crystal panel 130, and other information.

The analysis unit 150 obtains information on the display brightness. In the present embodiment, the analysis unit 150 analyzes the image to be displayed and obtains a representative brightness, which is the display brightness representing the image.

The view angle of the display apparatus 100 may be reduced (narrowed) depending on the relationship between the display brightness, the transmittance of the first liquid crystal panel 120, and the transmittance of the second liquid crystal panel 130. The principle of this problem is described below.

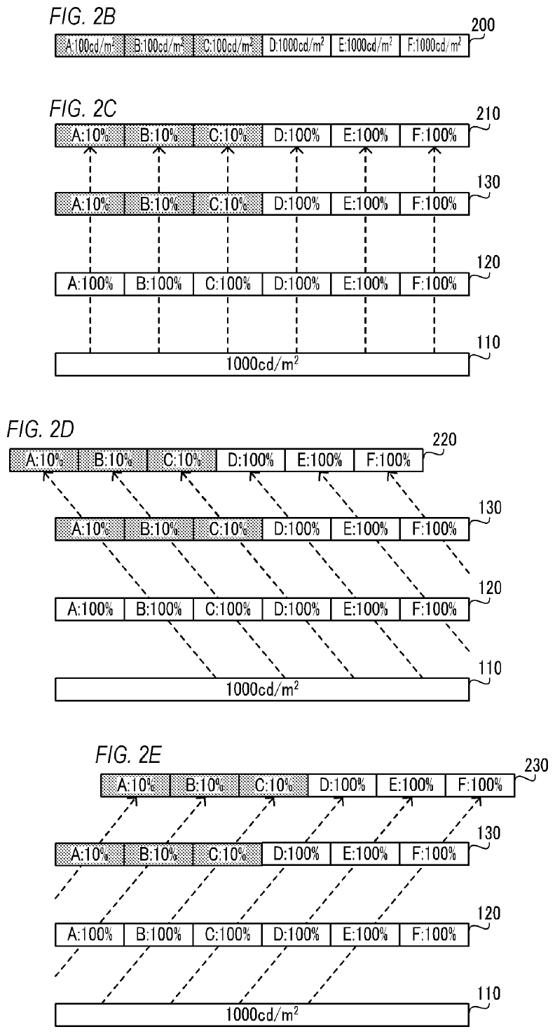

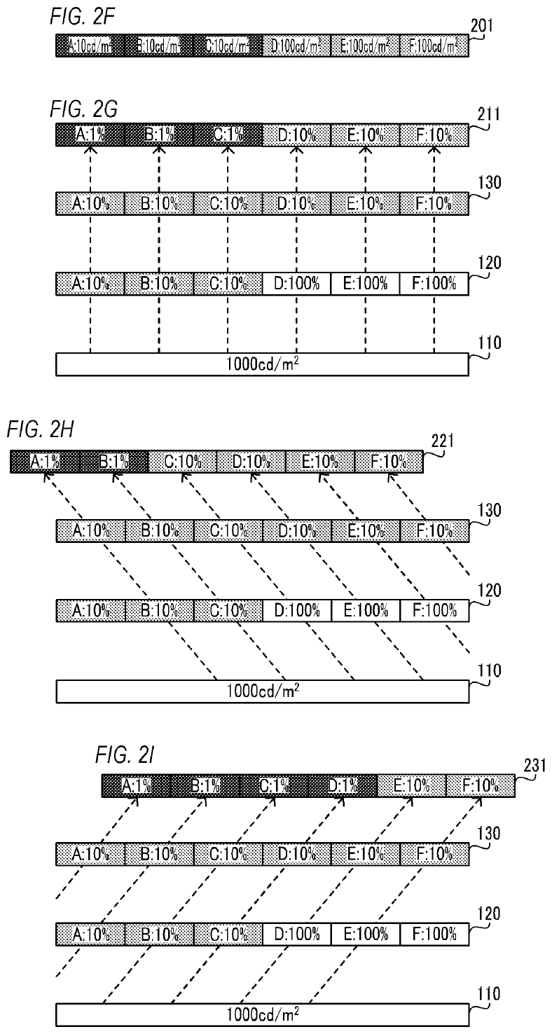

FIG. 2A shows an example of the relationship between the display brightness, the transmittance of the first liquid crystal panel 120, and the transmittance of the second liquid crystal panel 130 for display with a display brightness of 1 to 1000 cd/m². In the example of FIG. 2A, for display with 1000 cd/m², the transmittance of the first liquid crystal panel 120 and the transmittance of the second liquid crystal panel 130 are both set to 100%. For display with 100 cd/m², the transmittance of the first liquid crystal panel 120 is set to 100%, and the transmittance of the second liquid crystal panel 130 is set to 10%. For display with 10 cd/m², the transmittance of the first liquid crystal panel 120 and the transmittance of the second liquid crystal panel 130 are both set to 10%. For display with other display brightness, the transmittance of the first liquid crystal panel 120 and the transmittance of the second liquid crystal panel 130 are also set according to the relationship of FIG. 2A.

FIGS. 2B to 2E show an example of control according to the relationship of FIG. 2A in which the view angle is not reduced.

FIG. 2B shows an image 200 (a part of an image) to be displayed. In the image 200, Pixels A, B, C, D, E, and F are arranged in this order. Pixels A to C are displayed with a brightness of 100 cd/m², and Pixels D to F are displayed with a brightness of 1000 cd/m².

FIGS. 2C to 2E show the light emission brightness of the backlight 110, the transmittance of the first liquid crystal panel 120, and the transmittance of the second liquid crystal panel 130 set to display the image 200. In FIGS. 2C to 2E, the broken lines indicate the paths of light emitted by the backlight 110 and transmitted through the first and second liquid crystal panels 120 and 130.

The portion designated by numeral 210 in FIG. 2C indicates the proportions of the transmitted light perceived when the display apparatus 100 (display surface) is viewed directly from the front, to the light emitted by the backlight 110 (the light before passing through the first liquid crystal panel 120). The transmitted light is the light that has been transmitted through the first and second liquid crystal panels 120 and 130 after emitted by the backlight 110. In Pixels A to C, the proportion of transmitted light is 10% (100% transmittance of the first liquid crystal panel 120×10% transmittance of the second liquid crystal panel 130). Thus, Pixels A to C are desirably perceived with 100 cd/m² (1000 cd/m² light emission brightness of the backlight 110×10% proportion of transmitted light). In Pixels D to F, the proportion of transmitted light is 100% (100% transmittance of the first liquid crystal panel 120×100% transmittance of the second liquid crystal panel 130). Thus, Pixels D to F are desirably perceived with 1000 cd/m² (1000 cd/m² light emission brightness of the backlight 110×100% proportion of transmitted light).

The portion designated by numeral 220 in FIG. 2D indicates the proportions of the transmitted light perceived when the display apparatus 100 is viewed at an angle, to the light emitted by the backlight 110. Since the proportion of transmitted light is 10% in Pixels A to C, Pixels A to C are desirably perceived with 100 cd/m². Likewise, since the proportion of transmitted light is 100% in Pixels D to F, Pixels D to F are desirably perceived with 1000 cd/m².

The portion designated by numeral 230 in FIG. 2E indicates the proportions of the transmitted light perceived when the display apparatus 100 is viewed at an angle opposite from that in FIG. 2D, to the light emitted by the backlight 110. Since the proportion of transmitted light is 10% in Pixels A to C, Pixels A to C are desirably perceived with 100 cd/m². Likewise, since the proportion of transmitted light is 100% in Pixels D to F, Pixels D to F are desirably perceived with 1000 cd/m².

As described above, the control according to the relationship of FIG. 2A enables the user to desirably view the display image (the image displayed on the display surface) from various directions for display with a display brightness range of 100 cd/m² to 1000 cd/m², for which the transmittance of the first liquid crystal panel 120 is not changed. That is, the user can visually perceive the displayed image with a wide view angle.

FIGS. 2F to 2I show an example of control according to the relationship of FIG. 2A in which the view angle is reduced.

FIG. 2F shows an image 201 (a part of an image) to be displayed. In the image 201, Pixels A, B, C, D, E, and F are arranged in this order. Pixels A to C are displayed with a brightness of 10 cd/m², and Pixels D to F are displayed with a brightness of 100 cd/m².

FIGS. 2G to 2I show the light emission brightness of the backlight 110, the transmittance of the first liquid crystal panel 120, and the transmittance of the second liquid crystal panel 130 set to display the image 201. In FIGS. 2G to 2I, the broken lines indicate the paths of light emitted by the backlight 110 and transmitted through the first and second liquid crystal panels 120 and 130.

The portion designated by numeral 211 in FIG. 2G indicates the proportions of the transmitted light perceived when the display apparatus 100 is viewed directly from the front, to the light emitted by the backlight 110. Since the proportion of transmitted light is 1% in Pixels A to C. Pixels A to C are desirably perceived with 10 cd/m². Likewise, since the proportion of transmitted light is 10% in Pixels D to F, Pixels D to F are desirably perceived with 100 cd/m².

The portion designated by numeral 221 in FIG. 2H indicates the proportions of the transmitted light perceived when the display apparatus 100 is viewed at an angle, to the light emitted by the backlight 110. Since the proportion of transmitted light is 1% in Pixels A and B, Pixels A and B are desirably perceived with 10 cd/m². Likewise, since the proportion of transmitted light is 10% in Pixels D to F, Pixels D to F are desirably perceived with 100 cd/m². However, since the proportion of transmitted light is 10% in Pixel C, Pixel C is perceived with 100 cd/m², instead of 10 cd/m².

The portion designated by numeral 231 in FIG. 2I indicates the proportions of the transmitted light perceived when the display apparatus 100 is viewed at an angle opposite from that in FIG. 2H, to the light emitted by the backlight 110. Since the proportion of transmitted light is 1% in Pixels A to C, Pixels A to C are desirably perceived with 10 cd/m². Likewise, since the proportion of transmitted light is 10% in Pixels E and F, Pixels F and F are desirably perceived with 100 cd/m² However, since the proportion of transmitted light is 1% in Pixel D, Pixel D is perceived with 10 cd/m², instead of 100 cd/m².

As described above, the control according to the relationship shown in FIG. 2A causes regions (pixels) with varying display brightnesses to be visually perceived differently depending on the viewing direction, for display with a display brightness range of up to 100 cd/m², for which the transmittance of the first liquid crystal panel 120 is changed. Specifically, Pixel C may be viewed with a brightness ten times the display brightness (brightness as viewed directly from the front; intended brightness), or Pixel D may be viewed with a brightness 1/10 times the display brightness. That is, the view angle is poor.

According to the principle described above, the view angle is not reduced with the display brightness range for which the transmittance of the first liquid crystal panel 120 is constant. For this reason, the control unit 140 of the present embodiment controls the display brightness range that limits reduction in the view angle according to the display brightness that represents the image to be displayed (representative brightness). The display brightness range that limits reduction in the view angle is a display brightness range for which a change in the transmittance of the first liquid crystal panel 120 corresponding to a change in the display brightness is limited to not more than a predetermined change, such as a display brightness range for which the transmittance of the first liquid crystal panel 120 is constant.

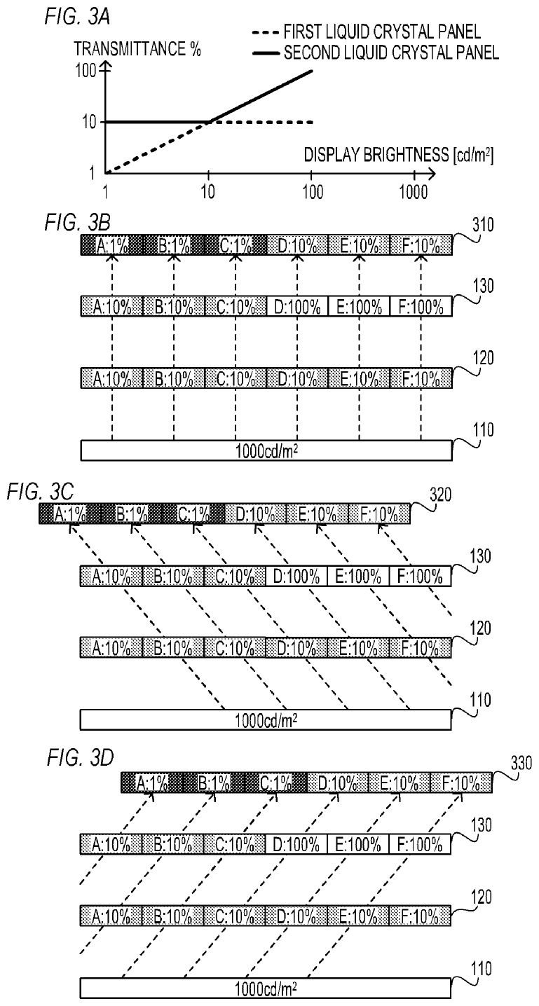

FIG. 3A shows an example of the relationship between the display brightness, the transmittance of the first liquid crystal panel 120, and the transmittance of the second liquid crystal panel 130 for display with a display brightness of 1 to 100 cd/m². In the example of FIG. 3A, for display with 100 cd/m², the transmittance of the first liquid crystal panel 120 is set to 10%, and the transmittance of the second liquid crystal panel 130 is set to 100%. For display with 10 cd/m², the transmittance of the first liquid crystal panel 120 and the transmittance of the second liquid crystal panel 130 are both set to 10%. For display with other display brightness, the transmittance of the first liquid crystal panel 120 and the transmittance of the second liquid crystal panel 130 are also set according to the relationship of FIG. 3A.

The example of FIG. 3A assumes that display with a display brightness higher than 100 cd/m² is not performed. Thus, unlike FIG: 2A, to accommodate a change in the display brightness from 10 cd/m² to 100 cd/m², the transmittance of the second liquid crystal panel 130 is increased, instead of increasing the transmittance of the first liquid crystal panel 120.

FIGS. 3B to 3D show an example of control according to the relationship of FIG. 3A, and show the light emission brightness of the backlight 110, the transmittance of the first liquid crystal panel 120, and the transmittance of the second liquid crystal panel 130 set to display the image 201 of FIG. 2F. In FIGS. 3B to 3D, the broken lines indicate the paths of light emitted by the backlight 110 and transmitted through the first and second liquid crystal panels 120 and 130.

The portion designated by numeral 310 in FIG. 3B indicates the proportions of the transmitted light perceived when the display apparatus 100 is viewed directly from the front, to the light emitted by the backlight 110. Since the proportion of transmitted light is 1% in Pixels A to C. Pixels A to C are desirably perceived with 10 cd/m². Likewise, since the proportion of transmitted light is 10% in Pixels D to F, Pixels D tip F are desirably perceived with 100 cd/m².

The portion designated by numeral 320 in FIG. 3C indicates the proportions of the transmitted light perceived when the display apparatus 100 is viewed at an angle, to the light emitted by the backlight 110. Since the proportion of transmitted light is 1% in Pixels A to C, Pixels A to C are desirably perceived with 10 cd/m². That is, Pixel C, which is perceived with 100 cd/m² according to the relationship of FIG. 2A, is desirably perceived with 10 cd/m². Likewise, since the proportion of transmitted light is 10% in Pixels D to F, Pixels D to F are desirably perceived with 100 cd/m².

The portion designated by numeral 330 in FIG. 3D indicates the proportions of the transmitted light perceived when the display apparatus 100 is viewed at an angle opposite from that in FIG. 3C, to the light emitted by the backlight 110. Since the proportion of transmitted light is 1% in Pixels A to C, Pixels A to C are desirably perceived with 10 cd/m². Likewise, since the proportion of transmitted light is 10% in Pixels D to F, Pixels D to F are desirably perceived with 100 cd/m². That is, Pixel D, which is perceived with 10 cd/m² according to the relationship of FIG. 2A, is desirably perceived with 100 cd/m².

In the control according to the relationship of FIG. 3A, the transmittance of the first liquid crystal panel 120 is set constant for the display brightness range of 10 cd/m² to 100 cd/m². This allows the user to visually perceive a desirable display image from various directions when display is performed with a display brightness of 10 cd/m² to 100 cd/m₂, as described above. That is, the user can visually perceive the displayed image with a wide view angle.

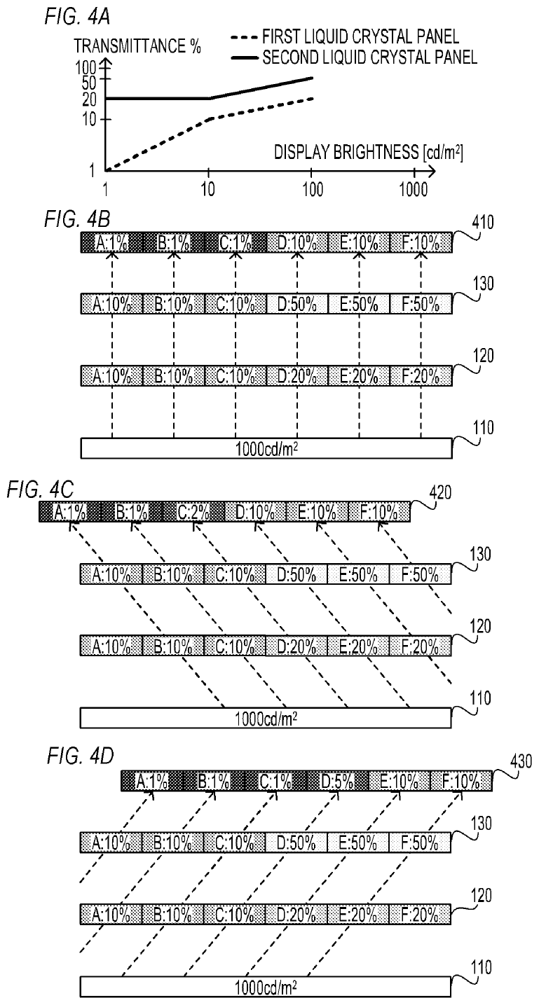

In the example described above, reduction in the view angle is avoided for a display brightness range for which the transmittance of the first liquid crystal panel 120 is constant. However, it is also possible to limit reduction in the view angle (to improve the view angle) by reducing a change in the transmittance of the first liquid crystal panel 120 corresponding to a change in the display brightness. For example, the transmittances of the first and second liquid crystal panels 120 and 130 may be controlled according to the relationship of FIG. 4A. According to the relationship of FIG. 2A, a change in the display brightness from 10 cd/m² to 100 cd/m² results in a change of ten times (change from 10% to 100%) in the transmittance of the first liquid crystal panel 120. In contrast, according to the relationship of FIG. 4A, a change in the display brightness from 10 cd/m² to 100 cd/m² results in a change of twice (change from 10% to 20%) in the transmittance of the first liquid crystal panel 120.

FIGS. 4B to 4D show an example of control according to the relationship of FIG. 4A, and show the light emission brightness of the backlight 110, the transmittance of the first liquid crystal panel 120, and the transmittance of the second liquid crystal panel 130 set to display the image 201 of FIG. 2F. In FIGS. 4B to 4D, the broken lines indicate the paths of light emitted by the backlight 110 and transmitted through the first and second liquid crystal panels 120 and 130.

The portion designated by numeral 410 in FIG. 4B indicates the proportions of the transmitted light perceived when the display apparatus 100 is viewed directly from the front, to the light emitted by the backlight 110. Since the proportion of transmitted light is 1% in Pixels A to C, Pixels A to C are desirably perceived with 10 cd/m². Likewise, since the proportion of transmitted light is 10% in Pixels D to F, Pixels D to F are desirably perceived with 100 cd/m².

The portion designated by numeral 420 in FIG. 4C indicates the proportions of the transmitted light perceived when the display apparatus 100 is viewed at an angle, to the light emitted by the backlight 110. Since the proportion of transmitted light is 1% in Pixels A and B, Pixels A and B are desirably perceived with 10 cd/m². Likewise, since the proportion of transmitted light is 10% in Pixels D to F, Pixels D to F are desirably perceived with 100 cd/m². Since the proportion of transmitted light is 2% in Pixel C Pixel C is perceived with 20 cd/m². That is, Pixel C, which is perceived with 100 cd/m² according to the relationship of FIG. 2A, is desirably perceived with 20 cd/m², which is close to 10 cd/m².

The portion designated by numeral 430 in FIG. 4D indicates the proportions of the transmitted light perceived when the display apparatus 100 is viewed at an angle opposite from that in FIG. 4C, to the light emitted by the backlight 110. Since the proportion of transmitted light is 1% in Pixels A to C, Pixels A to C are desirably perceived with 10 cd/m². Likewise, since the proportion of transmitted light is 10% in Pixels F and F, Pixels F and F are desirably perceived with 100 cd/m². Since the proportion of transmitted light is 5% in the pixel D, the pixel D is perceived with 50 cd/m². That is, the pixel D, which is perceived with 10 cd/m² according to the relationship of FIG. 2A, is desirably perceived with 50 cd/m², which is close to 100 cd/m².

In the control according to the relationship of FIG. 4A, a change in the transmittance of the first liquid crystal panel 120 is reduced for the display brightness range of 10 cd/m² to 100 cd/m². This allows the user to visually perceive a desirable display image from various directions when display is performed with a display brightness of 10 cd/m² to 100 cd/m², as described above. That is, the user can visually perceive the display image with a wide view angle. Specifically, the change in the perceived brightness of Pixel C (the brightness perceived by the user) is limited to a change to twice the display brightness, and the change in the perceived brightness of Pixel D is limited to a change to ½ times the display brightness.

According to the relationship of FIG. 4A, the transmittance of the first liquid crystal panel 120 is set to 20% for display with 100 cd/m², and is set to 10% for display with 10 cd/m². However, the transmittance of the first liquid crystal panel 120 and the range of change may be set freely. For display with a display brightness of 10 to 100 cd/m², it may be assumed that the user tolerates a change of 10% in the perceived brightness caused by a change in the viewing direction. In this case, the transmittance of the first liquid crystal panel 120 corresponding to a display brightness of 10 cd/m² is preferably 18%, which is 2% (10% of 20%) lower than the transmittance of 20% of the first liquid crystal panel 120 corresponding to a display brightness of 100 cd/m². In a similar manner, when the transmittance of the first liquid crystal panel 120 corresponding to a display brightness of 100 cd/m² is 50%, the transmittance of the first liquid crystal panel 120 corresponding to a display brightness of 10 cd/m² is preferably 45%, which is 5% (10% of 50%) lower than 50%. That is, in response to a change from the maximum display brightness to the minimum display brightness of the display brightness range that limits reduction in the view angle, the control unit 140 preferably changes the transmittance of the first liquid crystal panel 120 by an amount of change of not more than 10%.

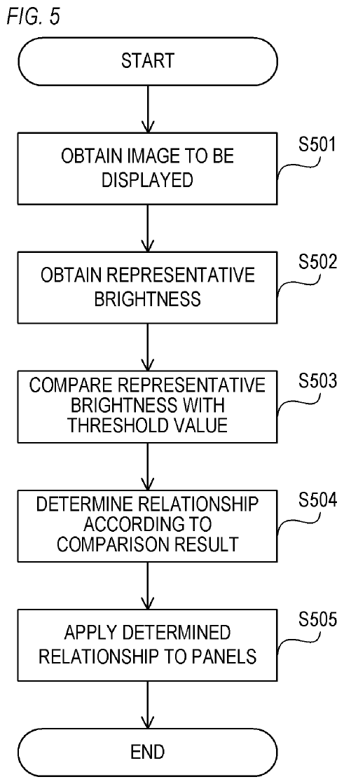

An example of the operation of the display apparatus 100 is now described. FIG. 5 is a flowchart showing an open example of the display apparatus 100.

At step S501, the analysis unit 150 obtains an image to be displayed (image data). The image to be displayed may be an image input from an input terminal, such as an FDMI terminal or an SDI terminal, an OSD image, such as a subtitle or a menu, or other images. The input image may be an image in which at least two images are arranged, such as an image in which an OSD image is superimposed on an image input from an input terminal. The image to be displayed may be a color image having a resolution (image size; number of pixels in the horizontal direction x number of pixels in the vertical direction) of 1920×1080 pixels. In the present embodiment, however, an example is described in which the image to be displayed is a black-and-white image having a resolution of 3×3 pixels.

At step S502, the analysis unit 150 analyzes the image obtained at step S501 to obtain a representative brightness, which is a display brightness representing the image. The analysis unit 150 outputs (transmits) the obtained representative brightness to the control unit 140. The analysis unit 150 may analyze the entire image to obtain a representative brightness of the entire image, or may analyze a region of the image to obtain a representative brightness of the region. The analysis unit 150 may individually analyze a plurality of regions in the image and obtain a representative brightness of each region. The analysis unit 150 may obtain a plurality of types of representative brightnesses for the same region. The representative brightness is a brightness indicating the brightness tendency of the image to be displayed. The representative brightness may be the average brightness, maximum brightness, minimum brightness, intermediate brightness, or most frequent brightness, for example.

At step S503, the control unit 140 obtains a threshold value (predetermined brightness) of representative brightness from the storage apparatus 160, and compares the representative brightness obtained at step S502 with the threshold value. The threshold value is preferably a value set taking into consideration 100% white brightness, which is a reference in high dynamic range (HDR) imaging. For example, the threshold value is preferably 1-ILG reference white 203 cd/m² specified in TR-B43 V1.2, which is a technical report of the Association of Radio Industries and Businesses (ARM). When the representative brightness is not more than the threshold value, the display brightness range that limits reduction in the view angle is preferably controlled to a range of not more than 203 cd/m² (for example, a range of 2 cd/m² to 203 cd/m²) by the process described below.

At step S504, the control unit 140 determines the relationship between the display brightness, the transmittance of the first liquid crystal panel 120, and the transmittance of the second liquid crystal panel 130 according to the comparison result of step S503. A plurality of pieces of information indicating the relationship between the display brightness, the transmittance of the first liquid crystal panel 120, and the transmittance of the second liquid crystal panel 130 may be associated with a plurality of comparison results and stored in the storage apparatus 160 in advance. Of the plurality of pieces of information, the control unit 140 may obtain from the storage apparatus 160 the information corresponding to the comparison result of step S503. The control unit 140 may generate information on the relationship between the display brightness, the transmittance of the first liquid crystal panel 120, and the transmittance of the second liquid crystal panel 131) according to the comparison result of step S503.

At step S505, the control unit 140 applies the relationship determined at step S504 to the first liquid crystal panel 120 and the second liquid crystal panel 130.

If a representative brightness is obtained for each of a plurality of regions in the image, steps S503 to S505 may be individually performed for each region. Alternatively, one region may be selected from a plurality of regions, and the relationship (the relationship between the display brightness, the transmittance of the first liquid crystal panel 120, and the transmittance of the second liquid crystal panel 130) determined based on the representative brightness of the selected region may be applied to the entire image. The selection of a region may be performed in any manner. The threshold value to be compared with the representative brightness may be changed according to the type of the representative brightness. When a plurality of types of representative brightness is obtained, one of the types of representative brightness may be selected, and steps S503 to S505 may be performed using the selected representative brightnesses. The selection of a representative brightness may be performed in any manner.

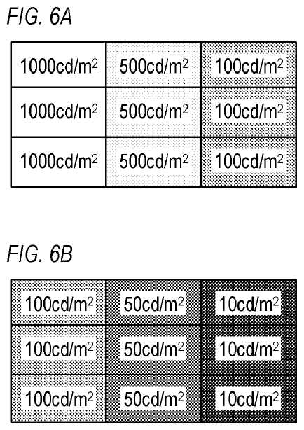

An example is now described in which the image of FIG. 6A is obtained at step S501. The image of FIG. 6A has three pixels of 1000 cd/m² (pixels displayed with 1000 cd/m²), three pixels of 500 cd/m², and three pixels of 100 cd/m². In this example, the average brightness (average display brightness) is obtained as the representative brightness.

At step S502, the analysis unit 150 obtains the average brightness of 533 cd/m². At step S503, the control unit 140 compares the average brightness of 533 cd/m² with the threshold value. The threshold value is 80 cd/m² in this example. It is therefore determined that the average brightness of 533 cd/m² is higher than the threshold value of 80 cd/m². At step S504, according to the determination result that the average brightness is higher than the threshold value, the control unit 140 obtains the relationship of FIG. 2A from the storage apparatus 160. At step S505, the control unit 140 controls the transmittances of the first and second liquid crystal panels 120 and 130 according to the relationship of FIG. 2A.

In this manner, when displaying the image of FIG. 6A having relatively high display brightnesses, a relatively high display brightness range (range of 100 cd/m² to 1000 cd/m²) is used to limit a change in the transmittance of the first liquid crystal panel 120. This advantageously limits reduction in the view angle.

An example is now described in which the image of FIG. 6B is obtained at step S501. The image of FIG. 6B has three pixels of 100 cd/m², three pixels of 50 cd/m², and three pixels of 10 cd/m².

At step S502, the analysis unit 150 obtains the average brightness of 53 cd/m². At step S503, the control unit 140 compares the average brightness of 53 cd/m² with the threshold value of 80 cd/m², and determines that the average brightness of 53 cd/m² is lower than the threshold value of 80 cd/m². At step S504, according to the determination result that the average brightness is lower than the threshold value, the control unit 140 obtains the relationship of FIG. 4A from the storage apparatus 160. Alternatively, the relationship of FIG. 3A may be obtained. When the representative brightness, such as the average brightness, is equal to the threshold value, the same relationship as when the representative brightness is lower than the threshold value may be obtained, or the same relationship as when the representative brightness is higher than the threshold value may be obtained. At step S505, the control unit 140 controls the transmittances of the first and second liquid crystal panels 120 and 130 according to the relationship of FIG. 4A.

In this manner, when displaying the image of FIG. 6B having relatively low display brightnesses, a relatively low display brightness range (range of 10 cd/m² to 100 cd/m²) is used to limit a change in the transmittance of the first liquid crystal panel 120. This advantageously limits reduction in the view angle.

Although the examples described above use the average brightness as the representative brightness, other representative brightness (e.g., the maximum brightness) may be used to perform more suitable control. An example is now described in which the maximum brightness (maximum display brightness) is used as the representative brightness. In this example, the image of FIG. 6B is obtained at step S501.

At step S502, the analysis unit 150 obtains the maximum brightness of 100 cd/m². At step S503, the control unit 140 compares the maximum brightness of 100 cd/m² with the threshold value. The threshold value is 100 cd/m² in this example. It is therefore determined that the maximum brightness of 100 cd/m² is not more than the threshold value of 100 cd/m². At step S504, according to the determination result that the maximum brightness is not more than the threshold value, the control unit 140 obtains the relationship of FIG. 4A from the storage apparatus 160. At step S505, the control unit 140 controls the transmittances of the first and second liquid crystal panels 120 and 130 according to the relationship of FIG. 4A.

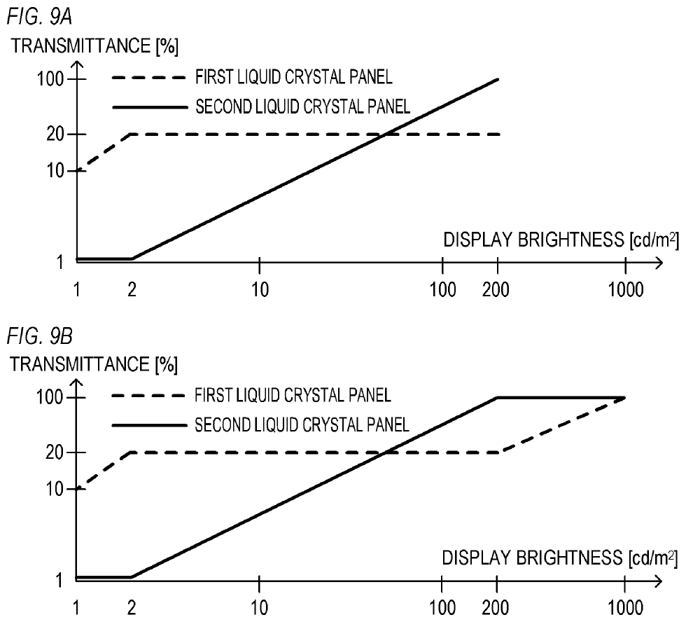

Although the threshold value is 100 cd/m² in the above example, the threshold value may be 200 cd/m². In that case, according to the determination result that the maximum brightness is not more than 200 cd/m², the relationship of FIG. 9A, which limits a change in the transmittance of the first liquid crystal panel 120 for a display brightness range of not more than 200 cd/m², may be used. The threshold value is not limited to these examples, and according to the determination result that the maximum brightness is not more than the threshold value, a relationship may be used that limits a change in the transmittance of the first liquid crystal panel 120 for a display brightness range of not more than the threshold value.

As described above, the present embodiment controls the display brightness range that limits reduction in the view angle (the display brightness range that limits a change in the first liquid crystal panel 120 corresponding to a change in the display brightness to not more than a predetermined change) based on the information on the display brightness. Specifically, when the representative brightness is lower than the predetermined brightness, the display brightness range that limits reduction in the view angle is controlled to be lower than when the representative brightness is higher than the predetermined brightness. As a result, the display brightness range that limits reduction in the view angle is controlled to a range suitable for the image to be displayed, thereby improving the view angle of the display apparatus of a dual-layer panel structure.

Although the representative brightness is obtained as the information on the display brightness in the above examples, the advantages described above may also be achieved using other information. For example, as information on the display brightness, information on the distribution of the display brightnesses of the image (such as a histogram) may be obtained. The display brightness range that limits reduction in the view angle may be controlled to a range that satisfies a predetermined condition that frequencies are concentrated in a histogram of the display brightnesses of the image. The predetermined condition may be any condition that indicates that frequencies are concentrated.

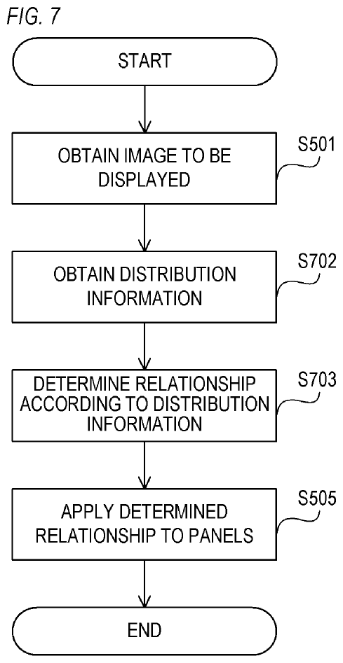

An example of an operation of the display apparatus 100 is now described in which distribution information (information on the distribution of the display brightnesses of the image) is obtained as information on the display brightness. FIG. 7 is a flowchart showing an operation example of the display apparatus 100. In FIG. 7, instead of steps S502 to S504 in FIG. 5, steps of S702 and S703 are performed.

At step S702, the analysis unit 150 analyzes the image obtained at step S501 to obtain information on the distribution of the display brightnesses of the image (distribution informatior). Then, the analysis unit 150 outputs (transmit;) the obtained distribution information to the control unit 140. The distribution information may be the range of display brightnesses of the image (the range from the minimum display brightness to the maximum display brightness of the image), the deviation or quartile obtained from the display brightness of each of a plurality of regions in the image, or other information on the distribution of the display brightnesses of the image. Each of the plurality of regions may be a region of one pixel, or a region including a plurality of pixels. As with the representative brightness obtainment method, various methods can be used to obtain the distribution information.

At step S703, the control unit 140 determines the relationship between the display brightness, the transmittance of the first liquid crystal panel 120, and the transmittance of the second liquid crystal panel 130 according to the distribution information obtained at step S702. For example, a relationship is determined that limits a change in the transmittance of the first liquid crystal panel 120 for the display brightness range in which frequencies are concentrated in a histogram of the display brightnesses of the image. A plurality of pieces of information indicating the relationship between the display brightness, the transmittance of the first liquid crystal panel 120, and the transmittance of the second liquid crystal panel 130 may be associated with a plurality of pieces of distribution information and stored in the storage apparatus 160 in advance. Of the plurality of pieces of information, the control unit 140 may obtain from the storage apparatus 160 the information corresponding to the distribution information obtained at step S702. The control unit 140 may generate information specifying the relationship between the display brightness, the transmittance of the first liquid crystal panel 120, and the transmittance of the second liquid crystal panel 130 according to the distribution information obtained at step S702.

As with the process method used to obtain a plurality of representative brightnesses, various methods may be used as the process method to obtain a plurality of pieces of distribution information.

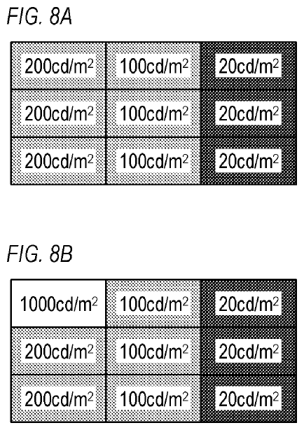

An example is now described in which the image of FIG. 8A is obtained at step S501 in FIG. 7. The image of FIG SA has three pixels of 200 cd/m², three pixels of 100 cd/m², and three pixels of 20 cd/m².

At step S702, the analysis unit 150 determines that the range from the minimum brightness (minimum display brightness) to the maximum brightness (maximum display brightness) of the image to be displayed is a range of 20 cd/m² to 200 cd/m². At step S703, the control unit 140 determines the relationship that limits a change in the transmittance of the first liquid crystal panel 120 for the display brightness range determined at step S702. Specifically, the relationship of FIG. 9A, which limits a change in the transmittance of the first liquid crystal panel 120 for the range of 20 cd/m² to 200 cd/m², is determined. At step S505, the control unit 140 controls the transmittances of the first and second liquid crystal panels 120 and 130 according to the relationship of FIG. 9A.

In this manner, when displaying the image of FIG. 8A having relatively low display brightnesses, a relatively low display brightness range (range of 2 cd/m² to 200 cd/m²) is used to limit a change in the transmittance of the first liquid crystal panel 120. This advantageously limits reduction in the view angle.

An example is now described in which the image of FIG. 8B is obtained at step S501 in FIG. 7. The image of FIG. 8B has one pixel of 1000 cd/m², two pixels of 200 cd/m², three pixels of 100 cd/m², and three pixels of 20 cd/m².

At step S702, the analysis unit 150 determines the quartile display brightnesses of the plurality of display brightnesses of the image to be displayed, and determines from the quartiles the range of display brightnesses that are not outliers. In this example, the first quartile is 20 cd/m², the second quartile is 100 cd/m², and the third quartile is 200 cd/m². Then, a range not more than the display brightness that is calculated by (first quartile−(third quartile first quartile)×1.5), and a range of at least the display brightness calculated by (third quartile +(third quartile first quartile)×1.5) are determined as the ranges of outliers. As a result, of the plurality of display brightnesses of the image to be displayed, 1000 cd/m², which is at least 470 cd/m² (=(200+(200−20)×1.5)), is determined as an outlier. The display brightness range of 20 cd/m² to 200 cd/m² is determined as the range of display brightnesses that are not outliers.

At step S703, the control unit 140 determines the relationship that limits at least a change in the transmittance of the first liquid crystal panel 120 for the display brightness range determined at step S702 (range of display brightnesses that are not outliers). Specifically, the relationship of FIG. 9B is determined that limits a change in the transmittance of the first liquid crystal panel 120 for the range of 2 cd/m² to 200 cd/m² in the same manner as the relationship of FIG. 9A. Since the image of FIG. 8B has a 1000 cd/m² pixel, the relationship of FIG. 9B, which supports a display brightness of up to 1000 cd/m², is determined instead of the relationship of FIG. 9A. As long as a change in the transmittance of the first liquid crystal panel 120 for the range of 20 cd/m² to 200 cd/m² is limited, it is not necessary to limit a change in the transmittance of the first liquid crystal panel 120 for the range of 2 cd/m² to 18 cd/m².

At step S505, the control unit 140 controls the transmittances of the first and second liquid crystal panels 120 and 130 according to the relationship of FIG. 9B.

In this manner, when displaying the image of FIG. 8B having a pixel of a relatively high brightness of 1000 cd/m², the range of 20 cd/m² to 200 cd/m², which corresponds to the major region of the image, is used to limit a change in the transmittance of the first liquid crystal panel 120. This advantageously limits reduction in the view angle. The view angle is not improved (increased) for the pixel of 1000 cd/m². The view angle of this pixel may be increased by other methods. For example, in the first liquid crystal panel 120, the transmittance of the pixels around a pixel whose view angle should be increased (target pixel; 1000 cd/m² pixel for example) may be increased to increase the view angle of the target pixel.

The two process methods used when the images of FIGS. 8A and 8B are obtained may be switched as appropriate. For example, when the maximum display brightness of the image is lower than the predetermined brightness, the display brightness range that limits reduction in the view angle may be controlled to the range from the minimum display brightness to the maximum display brightness of the image. When the maximum display brightness of the image is higher than the predetermined brightness, the display brightness range that limits reduction in the view angle may be controlled to the range of display brightnesses of the image that are not outliers. Furthermore, the method of determining outliers is not limited to the above method.

In the above example, information on the display brightness is obtained by analyzing the image to be displayed, but such information may be obtained by other methods. For example, the analysis unit 150 may obtain, as information on the display brightness, information on a display mode of the display apparatus 100 set by a user operation. It is thus possible to obtain information on the display brightness even if the image to be displayed is not obtained, allowing the transmittance of the first liquid crystal panel 120 to be controlled to advantageously limit reduction in the view angle according to the display brightness range to be displayed.

For example, when the display mode is a display mode in which the maximum display brightness of the display brightness range to be displayed is lower than a predetermined brightness, the control unit 140 sets the display brightness range that limits reduction in the view angle to be lower than when the display mode is a display mode in which the maximum display brightness is higher than the predetermined brightness. Specifically, when the maximum display brightness of the display apparatus 100 is set to 100 cd/m², the control unit 140 does not perform display with a display brightness higher than 100 cd/m². Accordingly, the relationship between the display brightness and the transmittance of each panel is changed from the relationship of FIG. 2A to the relationship of FIG. 4A. The relationship of FIG. 2A results in a large change in the transmittance of the first liquid crystal panel 120 for a display brightness range of not more than 100 cd/m², but the relationship of FIG. 4A results in a small change in the transmittance. This advantageously limits reduction in the view angle.

The information on a display mode may be any information that specifies the display brightness. For example, the information on a display mode may be information indicating an HDR setting or a standard dynamic range (SDR) setting. The information on a display mode may indicate a perceptual quantization (PQ) setting, a Hybrid Log Gamma (HLD) setting, or the like, as an HDR setting. As for P setting, the information of the maximum display brightness of the image may be obtained as information on the display brightness from the metadata of the image to be displayed. As for SDR setting, the reference white 203 cd/m² may be identified as the maximum display brightness, for example.

A plurality of types of display having mutually different display brightness ranges may be performed together, and HDR display (display in HDR setting) and SDR display (display in SDR setting) may be performed together. In this case, the control unit 140 preferably performs the plurality of types of display with the same change in the transmittance of the first liquid crystal panel 120 corresponding to a change in the display brightness in the common display brightness range. For example, when SDR display of the image of FIG. 8A and HDR display of the image of FIG. 8B are performed together, the relationship of FIG. 9A is used to display the image of FIG. 8A, and the relationship of FIG. 9B is used to display the image of FIG. 8B. This allows the image of FIG. 8A and the image of FIG. 8B to be viewed in the same manner (e.g., with the same view angle) for the common display brightness range (a range of not more than 200 cd/m²).

The above-described embodiments (including modifications) are merely examples, and the present invention also includes configurations obtained by appropriately modifying or changing the above-described configurations within the scope of the present invention. The present invention also includes configurations obtained by appropriately combining the above-described configurations.

According to the present disclosure, the view angle of a display apparatus having a dual-layer panel structure is improved.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for perthrming the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2020-078369, filed on Apr. 27, 2020, which is hereby incorporated by reference herein in its entirety.

What is claimed is:

1. A display apparatus comprising:
a light source;
a first transmissive panel configured to transmit light emitted by the light source:
a second transmissive panel configured to transmit light transmitted through the first transmissive panel; and
at least one memory and at least one processor which function as:
an obtaining unit configured to obtain information on a display brightness; and
a control unit configured to control a transmittance of the first transmissive panel and a transmittance of the second transmissive panel, wherein
the control unit further controls, based on the information obtained by the obtaining unit, a display brightness range that limits a change in the transmittance of the first transmissive panel corresponding to a change in the display brightness to not more than a predetermined change.

2. The display apparatus according to claim 1, wherein
the obtaining unit obtains, as the information, a representative brightness that is a display brightness representing an image to be displayed, by analyzing the image, and
in a case where the representative brightness is lower than a predetermined brightness, the control unit controls the display brightness range to be lower than a case where the representative brightness is higher than the predetermined brightness.

3. The display apparatus according to claim 2, wherein
the predetermined brightness is 203 cd/m², and
in a case where the representative brightness is lower than the predetermined brightness, the control unit controls the display brightness range to a range not more than 203 cd/m².

4. The display apparatus according to claim 1, wherein the obtaining unit obtains the information on distribution of display brightnesses of an image to be displayed by analyzing the image.

5. The display apparatus according to claim 4, wherein the control unit controls the display brightness range to a range that satisfies a predetermined condition under which frequencies are concentrated in a histogram of the display brightnesses of the image.

6. The display apparatus according to claim 4, wherein the control unit controls the display brightness range to a range from a minimum display brightness to a maximum display brightness of the image.

7. The display apparatus according to claim 4, wherein the control unit controls the display brightness range to a range of display brightnesses of the image that are not outliers.

8. The display apparatus according to claim 4, wherein
in a case where a maximum display brightness of the image is lower than a predetermined brightness, the control unit controls the display brightness range to a range from a minimum display brightness to the maximum display brightness of the image; and
in a case where the maximum display brightness is higher than the predetermined brightness, the control unit controls the display brightness range to range of display brightnesses of the image that are not outliers.

9. The display apparatus according to claim 1, wherein
the obtaining unit obtains the information on a display mode of the display apparatus, and
in a display mode where a maximum display brightness is lower than a predetermined brightness, the control unit controls the display brightness range to be lower than a display mode where the maximum display brightness is higher than the predetermined brightness.

10. The display apparatus according to claim 1, wherein
the obtaining unit obtains the information on a maximum display brightness of an image to be displayed from metadata of the image, and
in a case where the maximum display brightness is lower than a predetermined brightness, the control unit controls the display brightness range to be lower than a case where the maximum display brightness is higher than the predetermined brightness.

11. The display apparatus according to claim 1, wherein in a case where the display brightness changes from a maximum display brightness to a minimum display brightness of the display brightness range, the control unit changes the transmittance of the first transmissive panel by an amount of change of not more than 10% of the change in the display brightness.

12. The display apparatus according to claim 1, wherein in a case where a plurality of types of display having mutually different display brightness ranges is performed together, the control unit performs the plurality of types of display with a same change in the transmittance of the first transmissive panel corresponding to a change in the display brightness in a common display brightness range.

13. A control method of a display apparatus including a light source, a first transmissive panel configured to transmit light emitted by the light source, and a second transmissive panel configured to transmit light transmitted through the first transmissive panel, the control method comprising:
obtaining information on a display brightness;
controlling a transmittance of the first transmissive panel and a transmittance of the second transmissive panel; and
controlling, based on the obtained information, a display brightness range that limits a change in the transmittance of the first transmissive panel corresponding to a change in the display brightness to not more than a predetermined change.

14. A non-transitory computer readable medium that stores a program, wherein the program causes a computer to execute a control method of a display apparatus including a light source, a first transmissive panel configured to transmit light emitted by the light source, and a second transmissive panel configured to transmit light transmitted through the first transmissive panel, the control method comprising:
obtaining information on a display brightness;
controlling a transmittance of the first transmissive panel and a transmittance of the second transmissive panel; and
controlling, based on the obtained information, a display brightness range that limits a change in the transmittance of the first transmissive panel corresponding to a change in the display brightness to not more than a predetermined change.
